(19) United States
(12) Patent Application Publication
(10) Pub. No.: US 2026/0242304 A1
(43) Pub. Date: Aug. 20, 2026

(54) A FERTILISER COMPOSITION BASED ON A BIOTISED, SEWAGE SLUDGE PYROLYSIS PRODUCT

(71) Applicant: GROOWN S.R.O., Strancice (CZ)

(72) Inventors: Michal HAUSENBLAS, Kamenice (CZ); Jaroslav FUKA, Brandýs nad Labem (CZ)

(73) Assignee: GROOWN S.R.O., Strancice (CZ)

(21) Appl. No.: 19/164,660

(22) PCT Filed: Mar. 14, 2024
(86) PCT No.: PCT/CZ2024/050014

§ 371 Date: Sep. 12, 2025

(30) Foreign Application Priority Data
Mar. 14, 2023 (CZ) PV 2023-100

(51) Int. Cl. C05F 7/00; C02F 11/10; C05F 11/02; C05F 11/08

(52) U.S. Cl. CPC C05F 7/00; C02F 11/10; C05F 11/02; C05F 11/08

(57) ABSTRACT

The present invention relates to a fertiliser composition comprising a product obtained at least partially by sewage sludge pyrolysis, at least one species of phosphate solubilising bacteria of the genus Pseudomonas, preferably Pseudomonas putida and/or Pseudomonas fluorescens, spores or mycelium of at least one fungal species selected from the group consisting of endomycorrhizal fungi, arbuscular mycorrhizal fungi, ectomycorrhizal fungi, ericoid mycorrhizal fungi and mycoparasitic fungi, and at least one fertilising component selected from the group consisting of vermicompost extract, humic acids, compost extract, plant or animal manure extract, freshwater or marine algae extract or yeast extract. The invention also relates to a method of producing said fertiliser composition.

### FIELD OF TECHNOLOGY

The present invention relates to a fertiliser composition based on a product obtained at least partially by sewage sludge pyrolysis, wherein said product is biotised and enriched with organic components.

### PRIOR ART

Biochar refers to charred biomass produced by pyrolysis. It is used, inter alia, as a fertiliser or soil conditioner to improve soil properties and natural soil fertility. Biochar is usually obtained by thermal reduction (pyrolysis) of biomass or other organic matter at temperatures between 45° and 800° C. Its composition and properties depend on the material from which it is made. If it is derived from plant or animal biomass, it usually comprises between 50 and 90% by weight of stable carbon and, in addition to carbon, usually about 1% by weight of phosphorus, 2% by weight of potassium, 6% by weight of calcium and 1.5% by weight of magnesium.

Sewage or waste sludge means the solid or semi-solid waste product of sewage treatment plants. The pyrolysis of this sludge can produce a biochar-like product, e. g. by the technology of PYREG GmbH and HST Hydrosystémy s.r.o. (available on 14 Mar. 2023 at http://www.hydrosystemy.cz/produkty/53-nakladani-s-kaly/55-zpracovani-kalu-pyrolyzou/67-pyrolyzni-modul-pyreg and at http://www.hydrosystemy.cz/files/files/2eu7ifoi_files/Zpracován%C3%AD%20čist%C3%ADrenského%20kalu.pdf), wherein the sludge is first gasified at a temperature of 550° C. to 600° C. and then carbonised by the supply of a controlled amount of air. The material is moved inside the reactor by a screw conveyor. The resulting product with a high phosphorus content is characterised by its granular composition and can be used as a soil additive to promote the formation of organic matter, which is a source of nutrients in soil substrates, leading to an increase in soil quality and productivity. The terms “biochar”, “product obtained by sewage sludge pyrolysis” and “sewage sludge pyrolysis product” are used interchangeably for the purposes of the present invention.

Fertiliser compositions comprising biochar obtained from sewage sludge pyrolysis and biotised by Pseudomonas putida and generally described spores of mycorrhizal fungi are known from, for example, U.S. Pat. No. 10,233,131 B2, EP 2834322 A4, US20190202749 A1 and U.S. Pat. No. 10,947,167 B2. The biotisation of the above biochar using only Pseudomonas putida is described in a series of publications by Qian et al. in 2019, 2020 and 2022. The disadvantage of these compositions is the absence of mycorrhizal fungi beneficial to plants, plant growth promoting bacteria and nitrogen fixing bacteria, thus it is not a full biofertiliser comprising sufficient amounts of macronutrients without additional supplementation with inorganic fertilisers.

Fertiliser compositions comprising biochar obtained by sewage sludge pyrolysis and biotised by Bacillus megatherium, Azotobacter spp, and other species, and optionally by spores of endomycorrhizal fungi are known from, e. g., EP 2718246 A4, CN 113880651 A, CN 111763118 A. In addition, the biotisation of said biochar by Bacillus megatherium alone is described in CN 104628484 B, CN 105777372 B, CN 112808234 A. The disadvantage of these compositions is the absence of phosphate solubilising bacteria, so it is not a complete biofertiliser comprising sufficient macronutrients without additional supplementation with inorganic fertilisers.

Czech utility model CZ 34889 U1 describes a microgranulated fertiliser comprising, in a first example, biochar obtained by pyrolysis of soft wood at 650° C. and enriched with ammonium phosphate and, in a second example, biochar obtained by pyrolysis of cereal straw at 450° C. and enriched with calcium phosphate. The disadvantage of this composition is that in both cases, the biochar has to be enriched with phosphate, and also the microgranulated composition is only achieved by using a binder comprising starch, and optionally urea.

Czech patent application CZ 20210592 A3 (not published at the priority date) describes a granular soil conditioner based on a mixture of organic fertiliser (e. g. animal excrement) and biotised biochar obtained by thermal reduction of plant biomass or animal bones, e. g. by thermal reduction of soft wood at 550° C. Biotisation is achieved by soil bacteria of the genus Pseudomonas and/or Bacillus, nitrifying bacteria of the genus Rhizobium and/or Azotobacter or Azospirillum, and spores of arbuscular mycorrhizal fungi (e. g. Glomus genus) and/or ectomycorrhizal fungi (e. g. Pisolithus, Scleroderma or Rhizopogon genus) and/or mycoparasitic fungi (e. g. Trichoderma or Pythium genus) and/or ericoid mycorrhizal fungi. The granular composition is achieved using a starch-comprising binder. The soil conditioner may further comprise vermicompost extract or ammonium phosphate.

In the prior art, there is therefore a need to provide a fertiliser based on a biotised product obtained from sewage sludge pyrolysis, which allows the use of all available macronutrients (phosphorus, potassium, nitrogen) by plants.

### SUMMARY OF THE INVENTION

The object of the invention is to provide a fertiliser composition based on a biotised product obtained by sewage sludge pyrolysis, which provides plants with all the necessary macronutrients (phosphorus, nitrogen, potassium) without the need for supplementation with inorganic fertilisers.

Said objective is achieved by a fertiliser composition comprising a product obtained at least partially by sewage sludge pyrolysis, at least one species of phosphate solubilising bacteria of the genus Pseudomonas, spores or mycelium of at least one fungal species selected from the group consisting of endomycorrhizal fungi, arbuscular mycorrhizal fungi, ectomycorrhizal fungi, ericoid mycorrhizal fungi and mycoparasitic fungi, and at least one fertiliser component selected from the group consisting of vermicompost extract, humic acids, compost extract, plant or animal manure extract, freshwater or marine algae extract or yeast extract.

The phosphate solubilising bacteria are preferably Pseudomonas putida and/or Pseudomonas fluorescens. The arbuscular mycorrhizal fungus is preferably Glomus spp., more preferably Glomus deserticola and/or Glomus intraradices and/or Glomus mosseae. The mycoparasitic fungus is preferably Trichoderma spp., more preferably Trichoderma harzianum. The fertilising component is preferably a vermicompost extract and/or a freshwater or marine algae extract.

Said composition may further comprise at least one species of plant growth promoting bacteria selected from the group consisting of the genera Bacillus and Burkholderia and/or at least one species of nitrogen fixing bacteria selected from the group consisting of the genera Rhizobium, Azotobacter and Azospirillum. The plant growth promoting bacteria are preferably Bacillus megatherium, Bacillus subtilis, Bacillus licheniformis, Bacillus thuringiensis, Bacillus velezenzis, Burkholderia cepacia and/or Burkholderia vietnamiensis. A particularly preferred embodiment is Bacillus megatherium. Preferably, the nitrogen fixing bacterium is Rhizobium leguminosarum, Rhizobium meliloti, Rhizobium huakuii, Rhizobium loti, Azotobacter chroococcum, Azospirillum lipoferum and/or Azospirillum brasilense.

Preferably, said composition may be in granular form, which is itself formed by sewage sludge pyrolysis without the need for a granulation step or the addition of binders.

Preferably, said composition may comprise a product obtained at least partially by sewage sludge pyrolysis, Pseudomonas putida, Pseudomonas fluorescens, Bacillus megatherium, Burkholderia spp, Azotobacter spp., Azospirillum spp., spores of the arbuscular mycorrhizal fungi Glomus deserticola, Glomus intraradices and Glomus mosseae, and spores of the mycoparasitic fungus Trichoderma harzianum.

The product is at least partially obtained by sewage sludge pyrolysis, e. g. medium temperature pyrolysis at a temperature of 630 to 670° C.

The underlying idea of the fertiliser composition according to the present invention is that it provides (in addition to other nutrients and micronutrients) phosphorus, nitrogen and potassium of biological origin to plants without the need for supplementation with synthetic fertilisers. The high phosphate content of the sewage sludge is made available in a form that is usable by plants by phosphate solubilising bacteria of the genus Pseudomonas, preferably Pseudomonas putida and/or Pseudomonas fluorescens. The plant growth promoting bacteria of the genus Bacillus and/or Burkholderia, preferably Bacillus megatherium, Bacillus subtilis, Bacillus licheniformis, Bacillus thuringiensis, Bacillus velezenzis, Burkholderia cepacia and/or Burkholderia vietnamiensis, synthesize the growth phytohormone auxin. Airborne nitrogen fixing bacteria of the genera Rhizobium, Azotobacter and/or Azospirillum make nitrogen available in the soil in a form that can be used by plants.

Spores or mycelium of mycorrhizal and/or mycoparasitic fungi generally contribute to better growth and yield, increased tolerance to drought and nutrient deficiencies, higher resistance to negative environmental influences (high salinity, soil contamination) and plant resistance to pathogens.

The spores or mycelium of arbuscular mycorrhizal fungi, such as Glomus deserticola, Glomus intraradices and/or Glomus mosseae, form an extensive network of fungal structures (hyphae, vesicles, arbuscules) in the cells of the root cortex after penetrating through the rhizodermis and then outside the root, the so-called arbuscules. The mycelia are able to transport water and nutrients (P, N, K, Zn, Cu, Mg) into the root of the plant. Mycelial hyphae also produce a specific glycoprotein, glomalin, which increases the stability of soil macroaggregates and reduces soil erosion.

Plants inoculated with spores or mycelium of mycoparasitic fungi, especially Trichoderma spp., e. g. Trichoderma harzianum, show higher nutrient uptake, increased growth, increased root hair formation and higher resistance to fungal pathogens on roots.

The vermicompost extract as a fertilising component supplies the fertiliser with potassium of biological origin and is also advantageously used in cooling the pyrolysed product from the pyrolysis reactor. The freshwater or marine algae extract has a similar effect.

The above-described composition increases soil fertility, increases soil water retention, improves regeneration of poor soils, improves the use of other fertilisers (retains and slowly releases them), and thus reduces the penetration of nutrients into groundwater.

Additionally, by adding it to the compost, the temperature of the compost is raised, water retention is increased, and the pH of the compost is raised. The recommended rate is 1 to 6 t dry matter/ha of soil (e. g. 1 or 2 or 5 t dry matter/ha), preferably the composition is mixed into a water suspension or into a suspension with a liquid fertiliser of organic or synthetic origin before incorporation into the soil.

The above objective is further achieved by a method of producing said fertiliser composition, comprising the following steps:
a. pyrolysing sewage sludge to form a sewage sludge pyrolysis product, preferably in a granular form (i. e. without the need to add binders, the granulate is formed spontaneously by pyrolysis);
b. cooling of the resulting sewage sludge pyrolysis product with the fertilising component, preferably the vermicompost extract and/or the freshwater or marine algae extract (e. g. an aqueous solution thereof at a dilution of 1:40), and drying the cooled sewage sludge pyrolysis product (e. g. to between 10 and 20% by weight of residual water content, preferably to a maximum of 15% by weight);
c. biotising the cooled and dried sewage sludge pyrolysis product in any order, preferably in the order i.-ii.-iii.-iv., with
   i. spores or mycelia of fungi selected from the group consisting of endomycorrhizal fungi, arbuscular mycorrhizal fungi, ectomycorrhizal fungi and ericoid mycorrhizal fungi, preferably spores or mycelia of arbuscular mycorrhizal fungi (e. g. on a silicate powder support), more preferably Glomus spp., most preferably Glomus deserticola and/or Glomus intraradices and/or Glomus mosseae;
   ii. at least one species of phosphate solubilising bacterium of the genus Pseudomonas (e. g. 0.1 to 1.0 g of each bacterium at a CFU concentration of 10⁹ per 1 g), preferably Pseudomonas putida and/or Pseudomonas fluorescens;
   iii. at least one species of plant growth-promoting bacterium, selected from the group consisting of the genera Bacillus and Burkholderia (e. g. 0.1 to 1.0 g of each bacterium at a concentration of 10⁹ CFU per 1 g) and/or at least one species of nitrogen fixing bacterium, selected from the group consisting of the genera Rhizobium, Azotobacter and Azospirillum (e. g. 0.1 to 1.0 g of each bacterium at a concentration of 10⁹ CFU per 1 g); and
   iv. spores of mycoparasitic fungi, preferably Trichoderma spp., more preferably Trichoderma harzianum (e. g. 0.1 to 1.0 g spores at a concentration of no more than 10 CFU⁵ per 1 g);
to form the biotised, sewage sludge pyrolysis product comprised in said fertiliser composition.

### BRIEF DESCRIPTION OF THE DRAWINGS

The nature of the invention is further explained by examples of its embodiments, which are described using the accompanying drawings, where:

FIG. 1 shows microscopic images of a part of a root colonized by mycelium of the arbuscular mycorrhizal fungi Glomus deserticola, Glomus intraradices and Glomus mosseae in composition E.

### EXAMPLES

An exemplary comparison of the macro- and micronutrient content and some physical parameters of the product obtained from pyrolysis of wood chips and a fertiliser composition comprising the product obtained from sewage sludge pyrolysis (according to claim 1) is summarized in Table 1. The fertiliser composition according to the present invention comprises more N, P, Ca, Fe, Cu and Zn compared to the biomass pyrolysis product. In particular, the higher P content is subsequently exploited by the presence of phosphate solubilising bacteria. The increased content of heavy metals (Cd, Cr, Pb) needs to be further analysed for the presence of these elements in the bioavailable fraction accessible to plants by means of long-term leaching tests.

TABLE 1
The content of macro- and micronutrients and some
physical parameters of the product obtained by pyrolysis
of wood chips (A) and sewage sludge (B).

| Parameter | Unit | A | B |
|---|---|---|---|
| Bulk weight | g/dm³ | 163 | 638 |
| Specific surface, S_{BET} | m²/g | 564 | 13.0 |
| Specific surface of mesopores, Sₘₑₛₒ | m²/g | 258 | 4.00 |
| Specific total pore volume, Vₜₒₜ | mm³_{liq}/g | 443 | 30.0 |
| Specific micropore volume, V_{micro} | mm³_{liq}/g | 162 | 5.00 |
| pH (water, 1:10) | — | 11.2 | 7.70 |
| Conductivity, EC (water 1:10) | mS/cm | 1.40 | 0.79 |
| Ash A^{d} | weight % | 10.6 | 64.3 |
| Volatile flammable substance V^{d} | weight % | 1.30 | 15.4 |
| Heat of combustion Qₛ^{d} | MJ/kg | 28.2 | 10.2 |
| Calorific value Qᵢ^{d} | MJ/kg | 28.0 | 9.90 |
| C content | weight % | 87.0 | 26.6 |
| H content | weight % | 0.91 | 1.10 |
| N content | weight % | 0.36 | 3.00 |
| Total S content | weight % | 0.23 | 0.30 |
| H/C ratio | — | 0.13 | 0.49 |
| C/N ratio | — | 283 | 10.3 |
| P content | g/kg | 0.89 | 47.4 |
| K content | g/kg | 3.90 | 3.60 |
| Ca content | g/kg | 16.4 | 49.0 |
| Mg content | g/kg | 2.85 | 12.2 |
| Na content | g/kg | — | 1.99 |
| Al content | g/kg | — | 27.7 |
| Fe content | g/kg | — | 84.6 |
| As content | mg/kg | <0.50 | 5.02 |
| Cd content | mg/kg | 0.20 | 2.63 |
| Cr content | mg/kg | 18.1 | 136 |
| Cu content | mg/kg | 30.0 | 515 |
| Hg content | mg/kg | 0.02 | 0.009 |
| Ni content | mg/kg | 21.0 | 36.6 |
| Pb content | mg/kg | 8.30 | 73.3 |
| Zn content | mg/kg | 429 | 1620 |

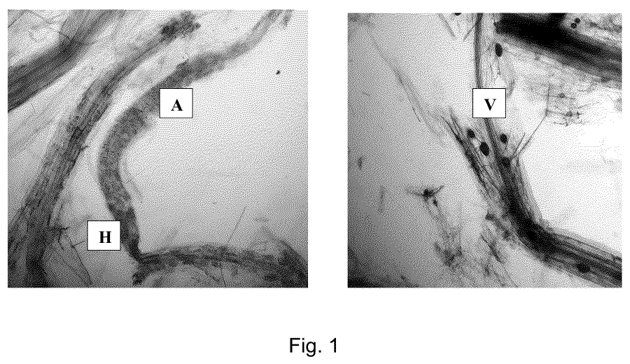

In a first example embodiment, compositions A-E of a fertiliser comprising a product (10 g) obtained by sewage sludge pyrolysis, Pseudomonas putida bacterium (10⁶ CFU), Pseudomonas fluorescens bacterium (10⁶ CFU), and spores of arbuscular mycorrhizal fungi (0.1 g, abbreviated AMH) Glomus deserticola, Glomus intraradices, and Glomus mosseae (equal parts) according to Table 2. The above compositions were added to maize (Zea mays) plants grown in 1 L pots in a greenhouse in an autoclaved zeolite: sand substrate in a 3:2 ratio. The control was composition F, a synthetic fertiliser NPK Microstar at 5 g/pot. The amount of each component in parentheses is given per 1 L pot, see Table 2. The dry weight (g), the weight of maize female inflorescence (g) and the length of colonized roots due to mycorrhizal inoculum (%) are given in Table 3 and mycorrhizal colonization of roots (arbuscules A, hyphae H and vesicles V) is shown in FIG. 1 (coloured in trypan blue).

TABLE 2
Composition A-F.

| Component | A | B | C | | D | | E | | F |
|---|---|---|---|---|---|---|---|---|---|
| Product | 10 g | 10 g | 10 | g | 10 | g | 10 | g | — |
| obtained by | | | | | | | | | |
| sewage sludge | | | | | | | | | |
| pyrolysis | | | | | | | | | |
| AMH | — | 0.1 g | 0.1 | g | 0.1 | g | 0.1 | g | — |

| | | | | | | | | |
|---|---|---|---|---|---|---|---|---|
| P. putida | — | — | 10⁶ | CFU | — | 10⁶ | CFU | — |

| | | | | | | | | |
|---|---|---|---|---|---|---|---|---|
| P. fluorescens | — | — | — | 10⁶ | CFU | 10⁶ | CFU | — |

| | | | | | | |
|---|---|---|---|---|---|---|
| NPK Microstar | — | — | — | — | — | 5 g |

TABLE 3
Results of the maize experiment.

| | | Weight of | Length of |
|---|---|---|---|
| | Dry | female | colonized |
| | weight | inflorescence | roots |
| Composition | (g) | (g) | (%) |
| A | 3.1 | 1.3 | 0 |
| B | 3.4 | 1.5 | 15 |
| C | 3.8 | 2.3 | 42 |
| D | 3.8 | 2.4 | 55 |
| E | 5.0 | 2.6 | 58 |
| F | 2.8 | 1.0 | 0 |

From Table 3, the synergistic effect on the dry weight of maize, by the product obtained by sewage sludge pyrolysis, Pseudomonas putida, Pseudomonas fluorescens, and spores of the arbuscular mycorrhizal fungi Glomus deserticola, Glomus intraradices and Glomus mosseae can be seen for composition E, as the contribution of individual Pseudomonas putida and Pseudomonas fluorescens bacteria is lower in compositions C and D than their combination in composition E. The additive effect can be seen in composition E in the resulting weight of female inflorescence and in the length of colonized roots. Bacillus megatherium, Burkholderia spp, and at least one nitrogen fixing bacterium (Rhizobium, Azotobacter, Azospirillum) may also be added to the above compositions C-E.

A second example is a method of producing a fertiliser composition, comprising a product obtained by sewage sludge pyrolysis, Pseudomonas putida, Pseudomonas fluorescens, Bacillus megatherium, Burkholderia spp., Azotobacter spp., Azospirillum spp., spores of the arbuscular mycorrhizal fungi Glomus deserticola, Glomus intraradices and Glomus mosseae, and spores of the mycoparasitic fungus Trichoderma harzianum. The sewage sludge is pyrolysed at a temperature of approximately 650° C. to produce a sewage sludge pyrolysis product in a granular form, which is subsequently cooled with an aqueous solution of vermicompost extract (1:40 dilution) and dried to a maximum residual water content of 15% by weight. The resulting cooled and dried sewage sludge pyrolysis product is biotised with spores of the arbuscular mycorrhizal fungi Glomus deserticola, Glomus intraradices and Glomus mosseae (the spores are on silicate dust support at a concentration of 5000 spores per 1 g of support). During the rotation of the granulate in the biotisation drum (max. 20 revolutions per min.), the powdered spore concentrate is gradually added (4 g of concentrate per 1 kg of granulate, i. e. 20 000 spores), i. e. the final value of spores per 1 g of granulate is 10, there are approximately 16-20 granules per 1 gram, i. e. the final concentration is at least 1 spore per granule. After biotisation with the spores of arbuscular mycorrhizal fungi (approximately 20 min), a mixture of phosphate solubilising bacteria Pseudomonas putida and Pseudomonas fluorescens (0.5 g from each lyophilized culture with a concentration of 10⁶ to 10⁹ CFU per 1 g, e. g., 10⁹ CFU per 1 g) is biotised in the same rotary drum. The next step is biotisation by mixtures of other bacteria (Azotobacter, Bacillus, Azospirillum and others) at the same dosage and concentration as for Pseudomonas. Finally, the mycoparasitic fungus Trichoderma harzianum is biotised on the surface of the granulate (0.5 g of powder culture at a concentration of CFU 10⁵ per 1 g, while higher concentrations of Trichoderma harzianum cannot be recommended due to possible inhibitory reaction and reduced development of mycorrhizal fungi). After addition of all biotising components, it is biotised in the drum at a constant rotation for about 20 min., and then the granulate is transferred to the final packaging (bags, big bags, etc.).

### INDUSTRIAL APPLICABILITY

The above-described fertiliser composition can be used in organic farming as a carbon negative fertiliser or soil conditioner.

1. A fertiliser composition, comprising
a. a product obtained at least partially by sewage sludge pyrolysis;
b. at least one species of phosphate solubilising bacteria of the genus Pseudomonas;
c. spores or mycelium of at least one fungal species selected from the group consisting of endomycorrhizal fungi, arbuscular mycorrhizal fungi, ectomycorrhizal fungi, ericoid mycorrhizal fungi and mycoparasitic fungi; and
d. at least one fertilising component selected from the group consisting of vermicompost extract, humic acids, compost extract, plant extract, animal manure extract, freshwater algae extract, marine algae extract, and yeast extract.

2. The composition according to claim 1, wherein the at least one phosphate solubilising bacterium is Pseudomonas putida and/or Pseudomonas fluorescens.

3. The composition according to claim 1 wherein the at least one fungal species is the arbuscular mycorrhizal fungus that is Glomus spp.

4. The composition according to claim 1, wherein the at least one fungal species is the mycoparasitic fungus that is Trichoderma spp.

5. The composition according to claim 1, wherein the at least one fertilising component is a vermicompost extract and/or a freshwater or marine algae extract.

6. The composition according to claim 1, further comprising at least one species of plant growth promoting bacteria selected from the group consisting of the genera Bacillus and Burkholderia and/or at least one species of nitrogen fixing bacteria selected from the group consisting of the genera Rhizobium, Azotobacter and Azospirillum.

7. The composition of claim 6, wherein the at least one species of plant growth promoting bacteria is of the genera Bacillus that is Bacillus megatherium.

8. The composition according to claim 1, which is in granular form.

9. The composition according to claim 1, comprising a product obtained at least partially by sewage sludge pyrolysis, Pseudomonas putida, Pseudomonas fluorescens, Bacillus megatherium, Burkholderia spp., Azotobacter spp., Azospirillum spp., spores of arbuscular mycorrhizal fungi Glomus deserticola, Glomus intraradices and Glomus mosseae, and spores of mycoparasitic fungus Trichoderma harzianum.

10. A method of producing the fertiliser composition according to claim 1, wherein the method comprises:
a. pyrolysing sewage sludge to form a sewage sludge pyrolysis product;
b. cooling the resulting sewage sludge pyrolysis product with the fertilising component, and drying the cooled sewage sludge pyrolysis product;
c. biotising of the cooled and dried sewage sludge pyrolysis product in any order, with
i. spores or mycelia of fungi selected from the group consisting of endomycorrhizal fungi, arbuscular mycorrhizal fungi, ectomycorrhizal fungi and ericoid mycorrhizal fungi;
ii. at least one species of phosphate solubilising bacterium of the genus Pseudomonas;
iii. at least one species of plant growth-promoting bacterium, selected from the group consisting of the genera Bacillus and Burkholderia, and/or at least one species of nitrogen fixing bacterium, selected from the group consisting of the genera Rhizobium, Azotobacter and Azospirillum; and
iv. spores of mycoparasitic fungi;
to form a biotised, sewage sludge pyrolysis product comprised in the fertiliser composition according to any one of the preceding claims.
